(19) United States
(12) Patent Application Publication
(10) Pub. No.: US 2024/0369430 A1
(43) Pub. Date: Nov. 7, 2024

(54) SYSTEMS FOR STRAIN DETECTION

(71) Applicant: Organic Robotics Corporation, Ithaca, NY (US)

(72) Inventors: Robert Shepherd, Ithaca, NY (US); Ilayda Samilgil, Syracuse, NY (US)

(21) Appl. No.: 18/285,606

(22) PCT Filed: Apr. 5, 2022
(86) PCT No.: PCT/US2022/023524

§ 371 Date: Oct. 4, 2023

Related U.S. Application Data
(60) Provisional application No. 63/170,927, filed on Apr. 5, 2021.

(51) Int. Cl. G01L 1/24

(52) U.S. Cl. CPC G01L 1/242

(57) ABSTRACT

Systems and methods for detecting strain are disclosed. In some embodiments, a system may include an optical fiber comprising one or more of a first end configured to receive light emitted by a light source, a second end configured to transmit light to a detector, a first fiber section having a first propagation loss parameter, and a second fiber section having a variable propagation loss parameter, the variable propagation loss parameter. In some embodiments, the variable propagation loss parameter may increase as the second fiber section is deformed.

### CROSS-REFERENCE TO RELATED APPLICATION

The present application claims priority to U.S. Provisional Application No. 63/170,927 filed on Apr. 5, 2021, the disclosure of which is incorporated herein in its entirety by reference.

### FIELD OF THE DISCLOSURE

This disclosure relates to systems and methods for detecting strain. Specifically, this disclosure relates to optical fibers, and methods for manufacturing and using optical fibers, for detecting strain.

### BACKGROUND

There are many applications in which it is desirable to detect strain, such as stretching, bending, or other deformation. For example, an athlete may wish to measure and monitor muscle or breathing activity, allowing exercise and performance to be better tracked and quantified, and overworking and injury risk can be reduced. Defense agencies may wish to obtain movement data for personnel or vehicles, to better preserve health and safety and to improve effectiveness and capabilities. In the field of robotics, it is often necessary to detect strain so that motions and interactions between parts may be coordinated. Further, strain detection may be used to receive instructions, such as by tracking a user's hand or body movements, which may cause a machine or computer to perform actions in response.

Often, these applications require a strain detection system that is soft, flexible, light, robust, and inexpensive to manufacture. U.S. Patent Publication No. 2019/0056248, which shares a common inventor with the present disclosure and is incorporated herein in its entirety, describes deformable waveguides that can be used for these purposes. Such waveguides may be limited, however, in terms of the length over which light may be propagated to obtain strain measurements. This can limit the number and types of applications to which the technology may be applied.

Accordingly, there is a need for systems and methods that provide strain detection using instrumentalities that are soft, flexible, light, robust, and inexpensive to manufacture. Further, there is a need for such instrumentalities to be unconstrained in their length, so that they may be used for a wider range of applications.

### SUMMARY

The following description presents a simplified summary in order to provide a basic understanding of some aspects described herein. This summary is not an extensive overview of the claimed subject matter. It is intended to neither identify key or critical elements of the claimed subject matter nor delineate the scope thereof.

In some embodiments, a system for detecting strain may include an optical fiber having a first end configured to receive light emitted by a light source, a second end configured to transmit light to a detector, a first fiber section having a first propagation loss parameter, and a second fiber section having a variable propagation loss parameter. The second fiber section may have an ultimate elongation of at least 10%, and the variable propagation loss parameter may increase as the second fiber section is deformed. The ultimate elongation of the second fiber section may be greater than an ultimate elongation of the first fiber section. The first fiber section may be coupled to the second fiber section. The optical fiber may be configured such that, when the first end is coupled to a light source and the second end is coupled, directly or indirectly, to a detector, light travels from the light source, through the first fiber section and the second fiber section, and to the detector.

In some embodiments, a method for producing a strain detection system may include forming an optical fiber comprising a first fiber section and a second fiber section. In some embodiments, the first fiber section may have a first propagation loss parameter, and the second fiber section having an ultimate elongation of at least 10% and a variable propagation loss parameter. The variable propagation loss parameter may increase as the second fiber section is deformed. In some embodiments, the ultimate elongation of the second fiber section may be greater than an ultimate elongation of the first fiber section. In some embodiments, the optical fiber may be configured such that, when a first end of the optical fiber is coupled to a light source and a second end of the optical fiber is coupled to a detector, light travels from the light source, through the first fiber section and the second fiber section, and to the detector.

In some embodiments, a method for detecting strain may include emitting light, the light traveling from a light source, through a first fiber section of an optical fiber, through a second fiber section of the optical fiber, and to a detector. The method may include receiving, at the detector, the light that has traveled through the first fiber section and the second fiber section. The method may include generating a measurement, using the detector, of the light that is received at the detector. The method may further include determining, using one or more processors, whether a strain is applied to the optical fiber based the measurement of the light that is received at the detector. In some embodiments, the method may be performed using a first fiber section having a first propagation loss parameter, and a second fiber section having an ultimate elongation of at least 10% and a variable propagation loss parameter. In some embodiments, the variable propagation loss parameter may increase as the second fiber section is stretched. In some embodiments, the measurement of the light received at the detector may vary when the second fiber section is stretched.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 shows an exemplary system for detecting strain.

FIGS. 2A-2C show an exemplary embodiment in which a first fiber section is bonded a second fiber section.

FIGS. 3A-3C show another exemplary embodiment in which a first fiber section is bonded a second fiber section.

FIG. 4 shows an exemplary arrangement for bonding fiber sections.

FIG. 5 shows an exemplary method for producing a strain detection system.

FIG. 6 shows an exemplary method for detecting strain.

FIG. 7 shows another exemplary method for producing a strain detection system.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

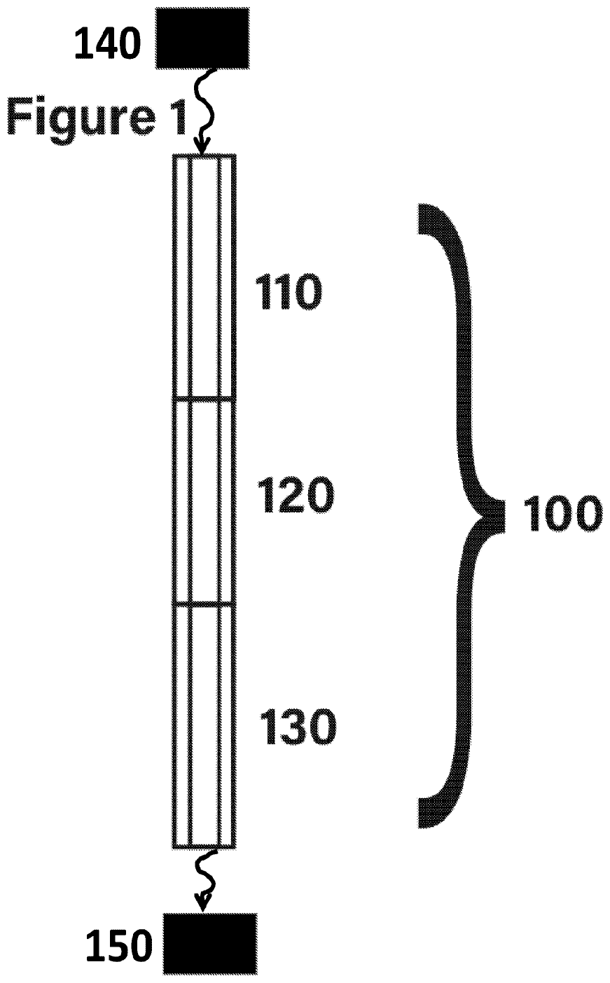

FIG. 1 shows an exemplary system 100 for detecting strain. In some embodiments, the system 100 may include one or more of a first fiber section 110, a second fiber section 120, and a third fiber section 130. The system 100 may further include a light source 140 and a detector 150. Although three fiber sections are shown in this exemplary embodiment, any number of fiber sections may be used. In some embodiments, the first fiber section 110 and third fiber section 130 may be low-loss fiber sections. For example, the first and/or third fiber sections may be composed of transparent plastic core of poly(methyl methacrylate). In other embodiments, the first and/or third fiber sections may be composed on glass. The core of the first and/or third fiber sections may have an optical attenuation coefficient of less than 0.1 dB cm⁻¹, less than 1 dB m⁻¹, or less than 0.1 dB m⁻¹. As used herein, the term optical attenuation coefficient is used to refer to optical loss per unit length. The term propagation loss parameter refers to the amount of optical loss over an entire length of a fiber. An index of refraction of the core of the first and/or third fiber sections may be approximately 1.5. In some embodiments, the first and/or third fiber sections may have a cladding. In some embodiments, the cladding may be made, in whole or in part, of Teflon. In some embodiments, the cladding may have an index of refraction approximately 1.4. In some embodiments, the first fiber section may have a length that is equal to or greater than 1 cm, 10 cm, 1 m, or 10 m. In some embodiments, the third fiber section may have a length that is equal to or greater than 1 cm, 10 cm, 1 m, or 10 m.

In some embodiments, the second fiber section may be an extensible fiber section in which a propagation loss parameter varies as the second fiber section is stretched. For example, the second fiber section may have an ultimate elongation of at least 5%, 10%, 20%, 50%, 75%, 100%, 150%, 200%, 300%, or 500%. In some embodiments, a propagation loss parameter may increase as the second fiber is stretched. For example, an optical attenuation coefficient of the second fiber section may be substantially constant, such that as a length of the second fiber section increases, a total amount of light loss over the length of the second fiber section may increase.

In some embodiments, the second fiber section may be composed of transparent elastomer core such as poly(urethane). The second fiber section may have an index of refraction approximately 1.5. The second fiber section may have an optical attenuation coefficient of approximately 0.01, 0.05, 0.1, 0.5, or 1 dB cm⁻¹. In some embodiments, the second fiber section may include a cladding. For example, the cladding may be made of an elastomer or plastic of lower index of refraction than the core. Silicone (having an index of refraction approximately 1.4), Teflon (having an index of refraction of approximately 1.4) are exemplary suitable materials. In some embodiments, the second fiber section may lack a cladding. For example, the second fiber section may be surrounded by air, which has an index of refraction of approximately 1.0. In some embodiments, the second fiber section may be a waveguide having any of the properties, or made according to any of the methods, described in U.S. Patent Publication No. 2019/0056248. In some embodiments the second segment may have a length that is greater than 0.05 cm, 0.1 cm, 0.5 cm, 1 cm, 2 cm, or 3 cm. In some embodiments, the second segment may have a length that is less than 5 cm, 10 cm, 20 cm, 50 cm, or 100 cm.

In some embodiments, the light source 140 may be a light-emitting diode. For example, a photodiode or laser diode may be used. In some embodiments, the light source may have a peak wavelength that is between 400 nm and 1 mm. In some embodiments, the detector 150 may be a phototransistor, photodiode, or complementary metal-oxide-semiconductor (CMOS). The fiber may have a first end that is configured to receive light emitted by the light source 140. For example, the light source 140 may be, e.g., attached to, disposed adjacent to, or embedded in whole or in part within the first end of the fiber, such that light emitted by the light source 140 may enter and pass through the core of the fiber. The detector may be arranged at a second end of the fiber, opposite the first, to receive light that travels through the fiber. For example, the detector 150 may be, e.g., attached to, disposed adjacent to, or embedded in whole or in part within the second end of the fiber, such that light that passes through the fiber may reach and be detected by the detector 150.

In some embodiments, the second fiber section may be bonded to the first fiber section such that light may pass from the first fiber section to the second fiber section. In embodiments that include an optional third fiber section, the third fiber section may be bonded to the second fiber section such that light may pass from the second fiber section to the third fiber section. Thus, the fiber may be arranged such that when the first end is coupled to a light source and the second end is coupled, directly or indirectly (e.g., via an optional third fiber section) to a detector, light travels from the light source, through the first fiber section, the second fiber section, and the optional third fiber section and to the detector.

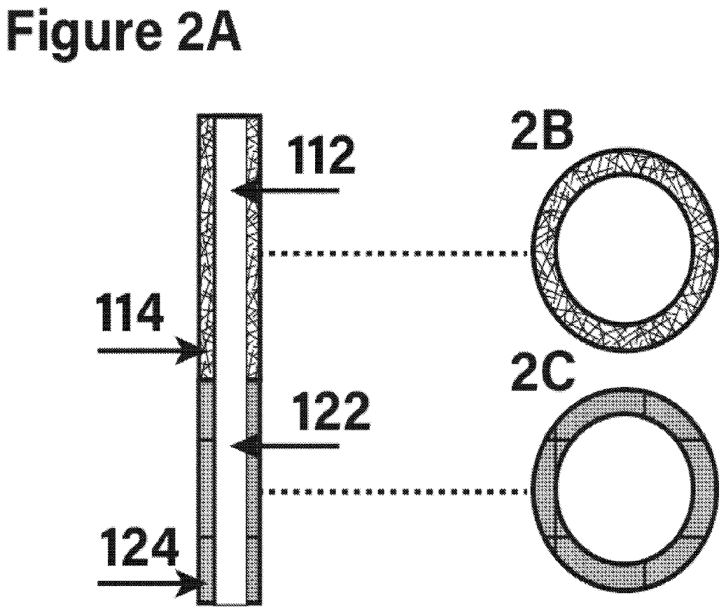

FIG. 2A shows an exemplary embodiment in which a first fiber section 110 is bonded a second fiber section 120. The first fiber section may include a core 112 and a cladding 114, and the second fiber section may include a core 122 and an optional cladding 124. In some embodiments, the first and second fiber sections may have different core and/or cladding materials. In some embodiments, the first and second fiber sections may have a common core. The common core may be made of a uniform material, which may be, for example, polyurethane, polyacrylate, or silicone. As discussed above, the second fiber section core 124 may be omitted such that the core 122 is in contact with air. In the embodiment illustrated in FIGS. 2A-2C, a common core having a uniform composition is covered by variable cladding sections 114, 124.

FIG. 2B shows a cross-section of the system of FIG. 2A taken at B-B. FIG. 2C shows a cross-section of the system of FIG. 2A taken at C-C.

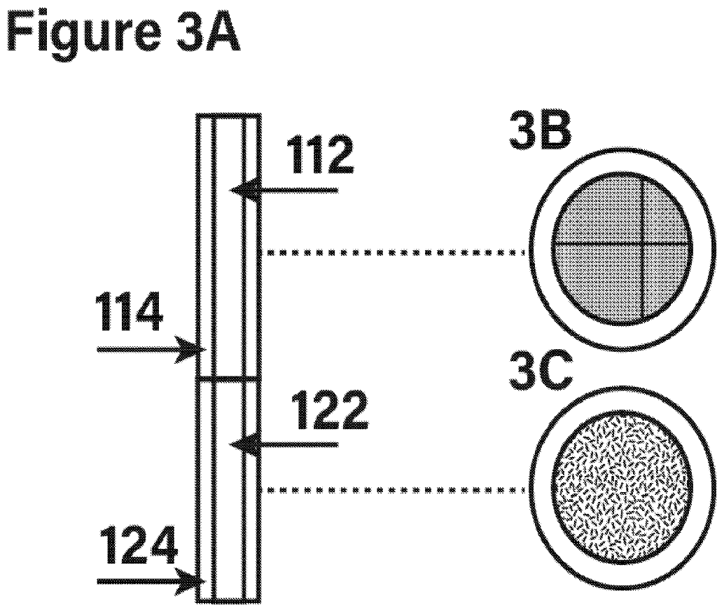

FIG. 3A shows another exemplary embodiment in which a first fiber section 110 is bonded a second fiber section 120. This embodiment is similar to that shown in FIGS. 2A-2C except that, in the embodiment shown in FIGS. 3A-3C, the composition of the cores in core sections 112 and 122 differ from one-another. In some embodiments, the core of the first section may be bonded to respective core of the second section. In some embodiments, the claddings 114, 124 of the first and second sections may have a common composition. For example, two or more core sections of different compositions may be bonded to one another, and a uniform cladding may be applied to cover the bonded core, thus producing a fiber having variable core composition and uniform cladding composition. In other embodiments, cladding of the same composition may be applied to cores of differing compositions, and the fiber sections may then be bonded together.

FIG. 3B shows a cross-section of the system of FIG. 3A taken at B-B. FIG. 3C shows a cross-section of the system of FIG. 3A taken at C-C.

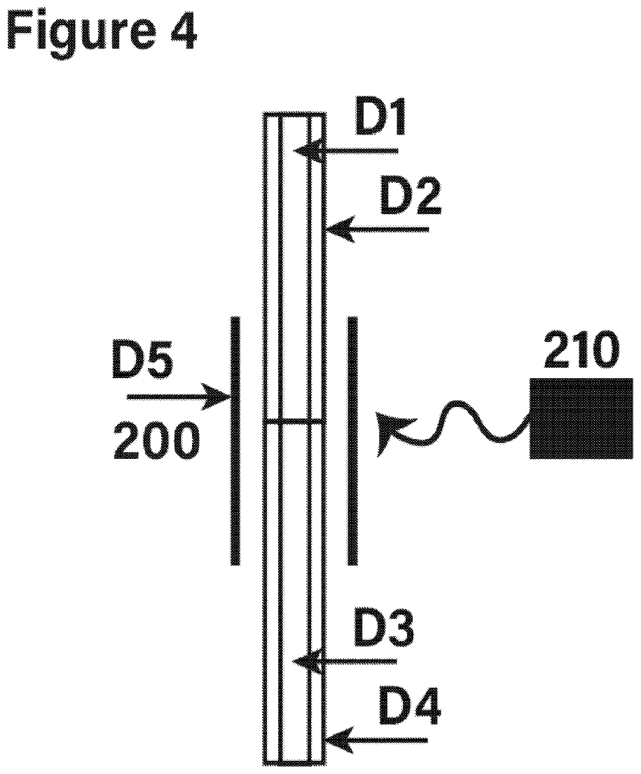

FIG. 4 shows an exemplary arrangement for bonding fiber sections. In some embodiments, a first fiber section and a second fiber section may be partially inserted into a collar 200. In some embodiments, the collar 200 may be configured to transmit energy. For example, the collar may be made from a glass or ceramic material that is configured to thermal, optical, or vibratory energy. In some embodiments, the collar may be made from a refractory ceramic material. The arrangement may further include an energy source 210. In some embodiments, the energy source may be a heating element, a laser, or a vibration element. The energy source 210 may be configured to apply energy to the collar, which may then be transmitted to the ends of the fiber sections to bond the fiber sections to one another. For example, the cores and/or claddings of the fiber sections may be made from thermoplastic materials such that when energy is applied by the energy source 210, the cores and/or claddings of the first and second fiber sections bond to one-another.

In some embodiments, the collar may have a diameter D5 sized to cover the first fiber section composed of core and cladding of diameters D1 and D2 respectively. The collar may also cover the second fiber section of core diameter D3 and cladding diameter D4. D5 may be larger than the greater of the sum of D2 and D1 or the sum of D3 and D4. In some embodiments, the sum of D1 and D2 may be substantially equal to the sum of D3 and D4. In some embodiments, the difference between D5 and the largest of these sums would be greater than 0.01 mm, 0.05 mm, 0.1 mm, or 0.3 mm to allow for envelopment of one core by the other.

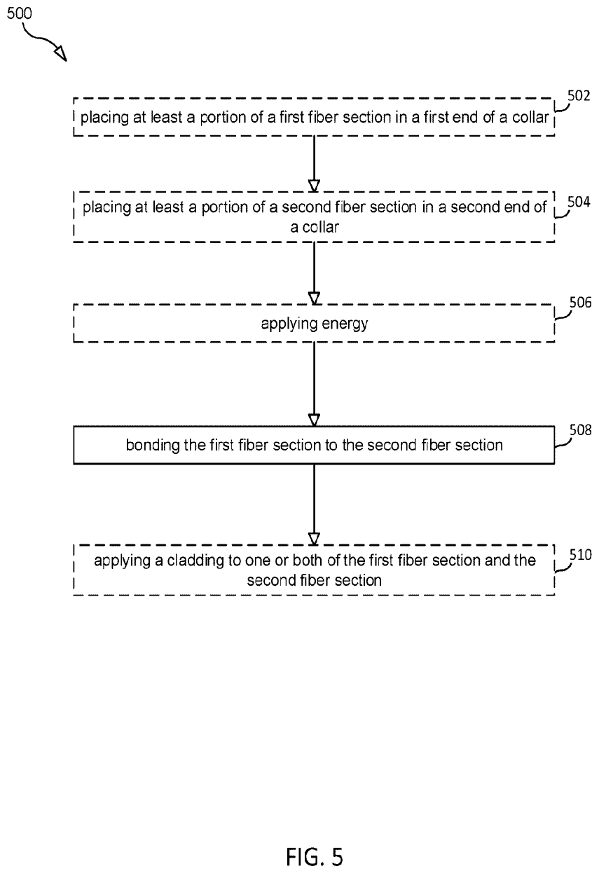

FIG. 5 shows an exemplary method 500 for producing a strain detection system. In step 502, a portion of a first fiber section may inserted into a first end of a collar. For example, as shown in FIG. 4, an end of the first fiber section 110 may be inserted into a first end of collar 200 such that it extends approximately halfway through the length of collar 200. In step 504, a portion of a second fiber section may be placed in a second end of the collar 200. For example, as shown in FIG. 4, and end of the second fiber section 120 may be inserted into a second end of collar 200 such that it contacts or nearly contacts the first fiber section 110. In step 140, energy may be applied to the collar 200, which may then be transmitted through the collar 200 to the junction of the first and second fiber sections. For example, heat (e.g. from a resistively heated tip, infrared laser, or any other suitable device) may be applied to collar 200 and transmitted to the junction of the first and second fiber sections. In embodiments where the cores and/or claddings of the fiber sections are made from thermoplastics, this may cause the material at this junction to melt or partially melt. In step 508, the first fiber section and second fiber section may be bonded together. For example, the application of energy to the collar 200 may cause the first fiber section and the second fiber section to bond by partially melting the material and, when the energy is removed, re-solidifying as a joint piece.

Optionally, fiber sections may be bonded to one another before or after a cladding is applied. For example, the collar may receive fiber sections including both cores and claddings, and steps 502-508 may cause the cores to bond to one another and/or the claddings to bond to one another. In some embodiments, only the cores may be bonded to one another (e.g., by selecting materials such that the energy applied is sufficient only to cause the cores to melt and join to one-another). In other embodiments, only the claddings may be bonded to one another (e.g., by selecting materials such that the energy applied is sufficiently only to cause the claddings to melt and join to one another). In still other embodiments, the collar may receive only cores without claddings, and steps 502-508 may cause the cores to bond to one another. In optional step 510, a cladding may be applied to one or both of the two cores. In this manner, a common cladding may cover a joint core having different materials at different positions. For example, a first section of the core may be low-loss and non-extensible, while a second section of the core may be lossy and extensible, with a variable propagation loss parameter that increases as the second section of the core extends or deforms.

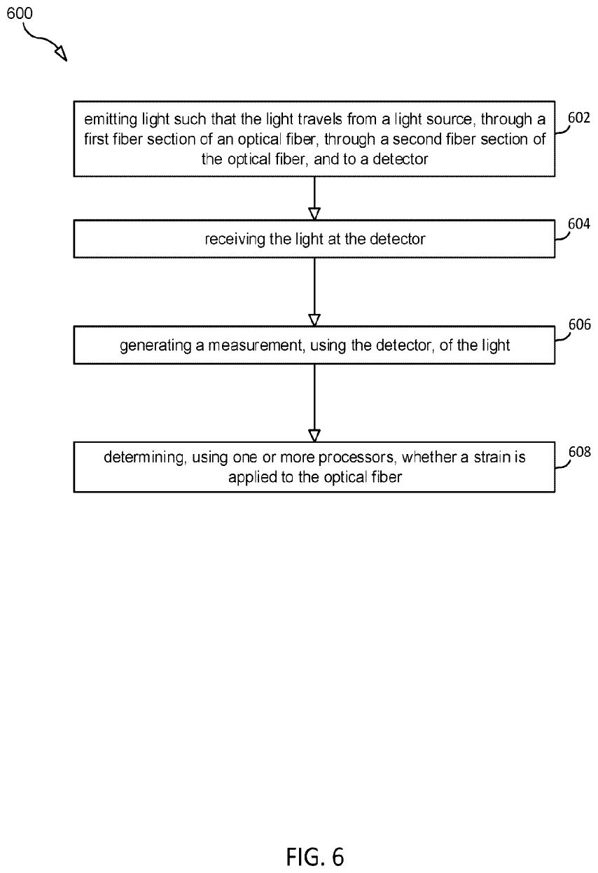

FIG. 6 shows an exemplary method 600 for detecting strain. In step 602, light may be emitted such that the light travels from a light source, through a first fiber section of an optical fiber, through a second fiber section of the optical fiber, and to a detector. For example, light may be emitted from electronic components (e.g., laser diode or photodiode). The light may travel through an optical fiber to a detector such as a phototransistor, photodiode, CMOS. In step 604, the detector may receive the light. In step 606, the system may generate a measurement, using the detector, of the received light. For example, the detector may generate a current and/or voltage output, which may indicate an amount of light that is received at the detector.

In step 608, the system may determine, using one or more processors, whether a strain is applied to the optical fiber. In some embodiments, the step of determining whether a strain is applied may include simply generating a yes/no value for whether a strain is applied. In other embodiments, the step of determining whether a strain is applied may include determining an amount of strain that is applied or characterizing the type of strain that is applied, such as by estimating whether the strain constitutes stretching or bending, and in what proportions.

For example, the output from the detector may be interpreted by one or more processors to determine an amount of light that is lost over the length of the optical fiber. In some embodiments, the system may have a baseline value that indicates an amount of light that is received by the detector when the optical fiber is in a non-deformed state. The system may compare a measured value to the baseline value to determine whether and by how much the measured value differs from the baseline value, thereby determining whether and how much the optical fiber is deformed. In some embodiments, the variation from the baseline state may be assumed to result from deformation to the second fiber section. In some embodiments, the system may store a value or set of values that indicate a relationship between deformation of the second fiber section and a propagation loss parameter of the second fiber section. In some embodiments, the system may use this value or set of values, in combination with an amount of light that is lost relative to the baseline value, to determine an amount of deformation of the second fiber section.

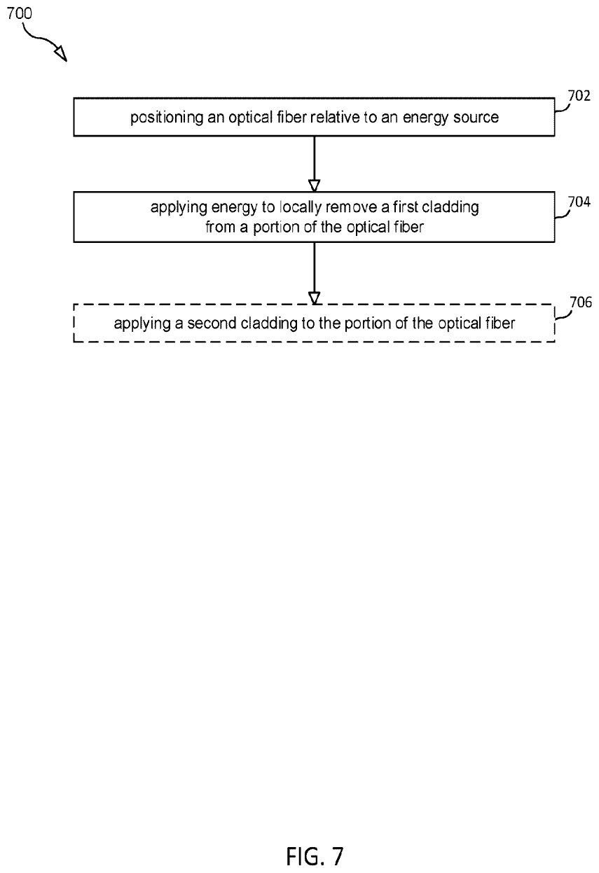

FIG. 7 shows an exemplary method 700 for producing a strain detection system. In step 702, an optical fiber may be positioned relative to an energy source. In some embodiments, the optical fiber may include a core and a cladding. In some embodiments, the material of the core and cladding may be uniform across the length of the fiber. In some embodiments, the core may be made from an extensible material, and the cladding may be made from a non-extensible material. In step 704, energy may be applied to locally remove the cladding from a selected portion of the optical fiber. In some embodiments, the energy may be applied using a laser or via mechanical stress from a blade. Steps 702 and 704 may thus produce a fiber having a first portion with a non-extensible cladding and a second portion that lacks the non-extensible cladding and may therefore be extensible. In some embodiments, the extensible second portion may have a variable propagation loss parameter that increases as the second portion is deformed. In optional step 706, a second cladding may be applied to the portion of the fiber from which the first cladding was removed. In some embodiments, the second cladding may be made from an extensible material, such that this portion of the fiber may remain extensible with a variable propagation loss parameter.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A system for detecting strain, the system comprising:
an optical fiber, the optical fiber comprising:
a first end configured to receive light emitted by a light source;
a second end configured to transmit light to a detector;
a first fiber section having a first propagation loss parameter;
a second fiber section having an ultimate elongation of at least 10% and a variable propagation loss parameter, the variable propagation loss parameter increasing as the second fiber section is deformed;
wherein the ultimate elongation of the second fiber section is greater than an ultimate elongation of the first fiber section; and
wherein the first fiber section is coupled to the second fiber section, the optical fiber being configured such that, when the first end is coupled to a light source and the second end is coupled, directly or indirectly, to a detector, light travels from the light source, through the first fiber section and the second fiber section, and to the detector.

2. The system of claim 1, further comprising:
a light source, the light source being arranged to transmit light through the first end of the optical fiber; and
a detector configured to receive light from the second end of the optical fiber;
wherein, when the light source emits light, the light travels through the first fiber section and the second fiber section to the detector.

3. The system of claim 2, wherein the light source is a light-emitting diode.

4. The system of any of claims 2-3, wherein a peak wavelength of the light source is between 400 nanometers and 1 millimeter.

5. The system of any of claims 1-4, wherein:
the first fiber section has a first core;
the second fiber section has a second core; and
the first core is bonded to the second core.

6. The system of claim 5, wherein each of the first core and the second core comprise respective thermoplastic or thermoset materials.

7. The system of any of claims 5-6, wherein the first fiber section has a first cladding, the second fiber section has a second cladding, the first cladding is bonded to the second cladding, and each of the first cladding and the second cladding comprise respective thermoplastic materials.

8. The system of any of claims 1-7, further wherein the optical fiber is formed by a process comprising bonding first fiber section is to the second fiber section by applying energy at a junction of the first fiber section and the second fiber section.

9. The system of any of claims 1-8, wherein the system is formed by a process comprising:
placing at least a portion of the first fiber section in a first end of a collar;
placing at least a portion of the second fiber section in a second end of the collar;
applying energy to the collar, the collar transmitting the energy to the first fiber section and the second fiber section;
wherein applying energy to the collar causes the first fiber section to bond to the second fiber section.

10. The system of claim 9, wherein the collar comprises a refractory ceramic material.

11. The system of any of claims 1-10, wherein the first fiber section has a length, and the first loss parameter divided by the length of the first fiber section is less than 1 dB per meter.

12. The system of any of claims 1-11, further wherein:
the optical fiber further comprises a third fiber section having a third propagation loss parameter, the third propagation loss parameter being less than the variable propagation loss parameter when the second fiber section is in the unstretched state; and
the second fiber section is bonded to the third fiber section such that the second fiber section is disposed between the first fiber section and the third fiber section, the optical fiber being configured such that, when the first end is coupled to a light source and the second end is coupled to a detector, light travels from the light source, through the first fiber section, the second fiber section, and the third fiber section, and to the detector.

13. The system of any of claims 1-12, further comprising a processor, the system being configured to determine whether a strain is applied to the system by measuring light transmitted through the optical fiber, the measurement varying when the second fiber section is stretched.

14. The system of any of claims 1-13, wherein:
when the second fiber section is in an unstretched state in which no external load is applied, the variable propagation loss parameter is greater than the first propagation loss parameter.

15. The system of any of claims 1-7 and 11-13, wherein:
when the first fiber section and the second fiber section comprise a common core, the common core having a uniform composition in both the first fiber section and the second fiber section.

16. The system of claim 15, wherein the optical fiber is formed by providing a common cladding over the common core and selectively removing the common cladding from the second fiber section, without removing the common cladding from the first fiber section.

17. A method for producing a strain detection system, the method comprising:
forming an optical fiber comprising a first fiber section and a second fiber section, the first fiber section having a first propagation loss parameter, and the second fiber section having an ultimate elongation of at least 10% and a variable propagation loss parameter, the variable propagation loss parameter increasing as the second fiber section is deformed;
wherein the ultimate elongation of the second fiber section is greater than an ultimate elongation of the first fiber section; and
wherein the optical fiber comprising the first fiber section and the second fiber section is configured such that, when a first end of the optical fiber is coupled to a light source and a second end of the optical fiber is coupled to a detector, light travels from the light source, through the first fiber section and the second fiber section, and to the detector.

18. The method of claim 17, further comprising:
disposing a light source such that light source being arranged to transmit light through a first end of the optical fiber; and
disposing a detector such that the detector is configured to receive light from a second end of the optical fiber;
emitting light using the light source, the emitted light travelling through the first fiber section and the second fiber section to the detector.

19. The method of claim 18, wherein the light source is a light-emitting diode.

20. The method of any of claims 18-19, wherein a peak wavelength of the light source is between 400 nanometers and 1 millimeter.

21. The method of any of claims 17-20, wherein:
the first fiber section has a first core;
the second fiber section has a second core; and
the first core is bonded to the second core.

22. The method of claim 21, wherein each of the first core and the second core comprise respective thermoplastic or thermoset materials.

23. The method of any of claims 21-22, wherein the first fiber section has a first cladding, the second fiber section has a second cladding, the first cladding is bonded to the second cladding, and each of the first cladding and the second cladding comprise respective thermoplastic materials.

24. The method of any of claims 17-23, further comprising:
bonding the first fiber section to the second fiber section by applying energy at a junction of the first fiber section and the second fiber section.

25. The method of any of claims 17-24, wherein the step of bonding the first fiber section to the second fiber section comprises:
placing at least a portion of the first fiber section in a first end of a collar;
placing at least a portion of the second fiber section in a second end of the collar;
applying energy to the collar, the collar transmitting the energy to the first fiber section and the second fiber section;
wherein applying energy to the collar causes the first fiber section to bond to the second fiber section.

26. The method of claim 25, wherein the collar comprises a refractory ceramic material.

27. The method of any of claims 17-26, wherein the first fiber section has a length, and the first loss parameter divided by the length of the first fiber section is less than 1 dB per meter.

28. The method of any of claims 17-27, further wherein:
the optical fiber further comprises a third fiber section having a third propagation loss parameter, the third propagation loss parameter being less than the variable propagation loss parameter when the second fiber section is in the unstretched state; and
the second fiber section is bonded to the third fiber section such that the second fiber section is disposed between the first fiber section and the third fiber section, the optical fiber being configured such that, when the first end is coupled to a light source and the second end is coupled to a detector, light travels from the light source, through the first fiber section, the second fiber section, and the third fiber section, and to the detector.

29. The method of any of claims 17-28, the method further comprising:
determining whether a strain is applied to the optical fiber by measuring light transmitted through the optical fiber, the measurement varying when the second fiber section is stretched.

30. The method of any of claims 17-29, wherein:
when the second fiber section is in an unstretched state in which no external load is applied, the variable propagation loss parameter is greater than the first propagation loss parameter.

31. The method of any of claims 17-23 and 27-29, wherein:
when the first fiber section and the second fiber section comprise a common core, the common core having a uniform composition in both the first fiber section and the second fiber section.

32. The method of claim 31, the method further comprising:
providing a common cladding over the common core; and
selectively removing the common cladding from the second fiber section, without removing the common cladding from the first fiber section.

33. A method for detecting strain, the method comprising:
emitting light, the light traveling from a light source, through a first fiber section of an optical fiber, through a second fiber section of the optical fiber, and to a detector;
receiving, at the detector, the light that has traveled through the first fiber section and the second fiber section;
generating a measurement, using the detector, of the light that is received at the detector;
determining, using one or more processors, whether a strain is applied to the optical fiber based the measurement of the light that is received at the detector;
wherein:
the first fiber section has a first propagation loss parameter;
the second fiber section having an ultimate elongation of at least 10% and a variable propagation loss parameter, the variable propagation loss parameter increasing as the second fiber section is stretched; and
the measurement of the light received at the detector varies when the second fiber section is stretched.

34. The method of claim 33, wherein the light source is a light-emitting diode.

35. The method of any of claims 33-34, wherein a peak wavelength of the light source is between 400 nanometers and 1 millimeter.

36. The method of any of claims 33-35, wherein:
the first fiber section has a first core;
the second fiber section has a second core; and
the first core is bonded to the second core.

37. The method of claim 36, wherein each of the first core and the second core comprise respective thermoplastic or thermoset materials.

38. The method of any of claims 36-37, wherein the first fiber section has a first cladding, the second fiber section has a second cladding, the first cladding is bonded to the second cladding, and each of the first cladding and the second cladding comprise respective thermoplastic materials.

39. The method of any of claims 33-38, wherein the optical fiber is formed by a process comprising bonding first fiber section is to the second fiber section by applying energy at a junction of the first fiber section and the second fiber section.

40. The method of any of claims 33-39, wherein the optical fiber is formed by a process comprising:
placing at least a portion of the first fiber section in a first end of a collar;
placing at least a portion of the second fiber section in a second end of the collar;
applying energy to the collar, the collar transmitting the energy to the first fiber section and the second fiber section;
wherein applying energy to the collar causes the first fiber section to bond to the second fiber section.

41. The method of claim 40, wherein the collar comprises a refractory ceramic material.

42. The method of any of claims 33-41, wherein the first fiber section has a length, and the first loss parameter divided by the length of the first fiber section is less than 1 dB per meter.

43. The method of any of claims 33-42, further wherein:
the optical fiber further comprises a third fiber section having a third propagation loss parameter, the third propagation loss parameter being less than the variable propagation loss parameter when the second fiber section is in the unstretched state; and
the second fiber section is bonded to the third fiber section such that the second fiber section is disposed between the first fiber section and the third fiber section, the optical fiber being configured such that the light emitted by the light source travels from the light source, through the first fiber section, the second fiber section, and the third fiber section, and to the detector.

44. The method of any of claims 33-41, wherein:
when the second fiber section is in an unstretched state in which no external load is applied, the variable propagation loss parameter is greater than the first propagation loss parameter.

45. The method of any of claims 33-37 and 40-44, wherein:
when the first fiber section and the second fiber section comprise a common core, the common core having a uniform composition in both the first fiber section and the second fiber section.

46. The method of claim 45, wherein the optical fiber is formed by a process comprising:
providing a common cladding over the common core; and
selectively removing the common cladding from the second fiber section, without removing the common cladding from the first fiber section.
